(19) United States
(12) Patent Application Publication
(10) Pub. No.: US 2008/0273437 A1
(43) Pub. Date: Nov. 6, 2008

(54) Device for and Method of Recording Information on a Record Carrier

(75) Inventors: Pope Ijtsma, Eindhoven (NL); Johannis Friso Rendert Blacquiere, Eindhoven (NL); Dirk Hamelinck, Beerzel (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,792

(22) PCT Filed: Jun. 24, 2005
(86) PCT No.: PCT/IB2005/052087

§ 371 Date: Dec. 18, 2006

(30) Foreign Application Priority Data
Jun. 29, 2004 (EP) 04103034.7

(51) Int. Cl. G11B 5/09

(52) U.S. Cl. 369/59.25

(57) ABSTRACT

A device for recording blocks of information on logical addresses on a record carrier at corresponding physical addresses. The logical addresses are translated into the physical addresses in dependence of remapping information (57, 63) indicative for translating a logical address initially mapped to a physical address to an alternate physical address in a remapping area (55), for example for defect management. The device can operate at two addressing modes corresponding to recording user data and additional data in separate areas. The device has storage means for storing additional data (54, 62) while maintaining addressing mode for storing data in the user area (53), the storage means being arranged for assigning an additional data physical address to the additional data, adapting the remapping information (57, 63) to indicate that the additional physical address is not available for storing user data, and directly recording the additional data at the additional data physical address.

The invention relates to a device for recording information in blocks having logical addresses in a user area on a record carrier, which device comprises recording means for recording marks in a track on the record carrier representing the information.

The invention further relates to a method of storing additional information for use in recording information in blocks having logical addresses in a user area.

The invention further relates to a computer program product for storing additional information for use in recording information.

Recording media like optical discs (DVD+RW, Blu-Ray, etc.) are capable of storing large amount of data of different types. They can be used in different environments having specific requirements as for organization of data on a recording medium. Typically, data are organized into files in accordance with rules of a particular file system. Such file system has its own file system data, which include information about all kind of structures relating to user data stored on a recording medium. In particular, file system data may include volume structures representing the structures of logical and/or physical volumes, file structures representing the structures of files containing the data, directory structures describing grouping of files, and a space bitmap representing allocated or unallocated space for storing data on a recording medium. A recording medium may comprise addressable recording units for storing the data. At a level of a file system those units are referenced to with use of logical addresses defining a contiguous addressing (storage) space to be used for storing sequences of information blocks, such as files under control (according to rules) of the file system, for example UDF. Partitioning of a recording medium allocates a space on the medium for storing data under control (according to rules) of a file system.

At present, for example, DVD+RW discs are in use by Consumer Electronics (CE) devices and in the Personal Computer (PC) environment. In the CE environment DVD+RW discs are used mainly for recording digital video information according to a specific format like DVD Video Recording (DVD+VR). This means that there are defined specific allocation rules and set of files containing the video information itself and information about that video information such as title information, menu structures, etc. For example, in the DVD+VR format some (file system) pointers are located at fixed address positions; also, certain files start at fixed addresses. Next to that the (predefined) list of files has to be physically on a medium in a certain order.

The PC environment is based on a different philosophy. There are, in principle, no allocation requirements. Specific applications may require some files to be present in a certain directory and specific application will typically have their own data format to store information in files or to retrieve information from a file. This means that as long as there is free space available on a medium it is possible to add data files to that medium from all kinds of different applications. As an example, on a single disc there could be multi-media files, text files and executable files all mixed with each other.

Recently, more and more CE devices, like video players/recorders, have capability to seek through the file system information on the disc for files of a certain type that they can handle as well. Example of this are (mainly) JPEG files and also, already more and more, MP3 files. In the future possibly more types of multi-media files will be supported in the CE world. Next to that, also new standards on meta-data are created (such as e.g. MPV or HighMAT) designed to make it easier to move digital content between PCs and home electronics devices.

The published international patent application WO 01/22416 A1 discloses the device capable of performing initialization, formatting and defect management of a rewritable medium such as a CD-RW disc. This is done to facilitate the use of CD-RW as a high-capacity floppy disc, so immediate writing or reading of files is possible. Such media are commonly referred to as Mount Rainier ReWritable MRW media, e.g. CD-MRW, DVD+MRW.

The device has recording means for recording the information in information blocks having logical addresses on an optical disc in a track at allocated physical addresses. The logical addresses constitute a contiguous storage space. In practice, the record carrier may exhibit defective parts of the track, in particular a defect preventing a block to be recorded at a specific physical address. These defects might be caused by scratches, dust, fingerprints and so on. Initially, before any user data is recorded, defects are detected, and physical addresses of defective sectors are removed from use in a defect table, a process usually called slipping. In the event of defects detected during use of the record carrier, logical addresses assigned to defective physical addresses in a user area UA are assigned to different physical addresses in a defect management area called also a spare area SA, a process usually called remapping or linear replacement.

Further, said device makes it possible to allocate a special part of a recording medium, called a general application area GAA, for storing additional data, e.g. file system data of a file system used by other devices. This facilitates sharing of such recording medium, so-called “bridge medium”, between different environments, e.g. the CE environment and the PC environment. In case of DVD+MRW media, GAA has a size of 2 MBytes.

The known device can operate in two modes. In a normal mode user data can be read/written from/to the user area, but not from/to GAA. In a special mode, a GAA mode, it is possible to read/write additional data from/to the general application area, but not from/to UA. The remapping is applied in the normal mode.

In the PC environment the most likely way of adding data to the bridge medium is by means of “drag-and-drop” technique. A user can then make the medium compatible with legacy players through the use of a compliance (bridge) application running on the PC. Basically, the bridge application writes second file system data, called “CE-bridge”, to the medium, using the suitable file system(s) and content pointers, such that a legacy “non-MRW” system can interpret these as content under its main file system. As a result, the CE-player will play the content that is referenced by this file system data, for which it has suitable content decoders.

During use of the medium in a MRW “drag-and-drop” environment employing the UA addressing mode, the content of the medium can be added, deleted or changed. These changes are tracked in the file system in the MRW user space; at a certain moment the CE-bridge needs to be updated with these changes. In order to do this, the bridge application needs to switch an operational mode from the normal mode to the GAA mode.

There is a problem when the MRW “drag-and-drop” environment is unaware of this, e.g. the GAA space is selected by the bridge application for an update and the MRW user space file system is also reading from the medium. This can lead to data corruption and requires inconvenient and complicated tracking of changes of the operational mode.

Therefore, it is an object of the invention to provide a way of storing/modifying additional information on the medium, such as second file system data, in the normal mode, without changing the operational mode.

This object is achieved, according to a first aspect of the invention, by a device of the type described in the opening paragraph, comprising control means for controlling the recording by locating each block at a physical address in the track, the control means comprising

addressing means for translating the logical addresses into the physical addresses and vice versa in dependence on remapping information;

remapping means for managing the remapping information relating to at least one remapping area, the remapping information being indicative for translating a logical address initially mapped to a physical address in the user area to an alternate physical address in the at least one remapping area; and

storage means for storing additional data, the storage means being arranged for

assigning an additional data physical address to the additional data and adapting the remapping information to indicate that the additional data physical address is not available for storing user data, and for

writing the additional data at the additional data physical address directly without said translating. This allows for storing/modifying additional data on the medium, without changing the operational mode.

In an embodiment of the device, the storage means are for storing file system data. This allows for creating/updating second file system data on the bridge medium.

In an embodiment of the device, the storage means are arranged for assigning the additional data physical address at a free physical address in the at least one remapping area and for adapting the remapping information to indicate that the free physical address is unusable for remapping. This embodiment is advantageous in that storing the additional data does not affect the user area.

In another embodiment of the device, the storage means are arranged for assigning the additional data physical address at a free logical address in the user area and for adapting the remapping information to indicate that the physical address corresponding to the free logical address needs remapping. This is advantageous in that it provides a possibility to very significantly increase a storage space for the additional data.

It is advantageous, if said adapted remapping information indicates a defect at the additional data physical address corresponding to the free logical address. This can be used to protect the additional data from being erased.

According to a second aspect of the invention a method of storing additional information for use in recording information of the type described in the opening paragraph is provided, which recording comprises

locating each block at a physical address in a track on the record carrier,

translating the logical addresses into the physical addresses and vice versa in dependence on remapping information, and

managing the remapping information relating to at least one remapping area, the remapping information being indicative for translating a logical address initially mapped to a physical address in the user area to an alternate physical address, the method comprising

assigning an additional information physical address to the additional information and adapting the remapping information to indicate that the additional information physical address is not available for storing user data;

writing the additional information at the additional information physical address directly without said translating.

According to a third aspect of the invention a computer program product for storing additional information is provided, which program is operative to cause a processor to perform the method as described in relation to the second aspect of the invention.

These and other aspects of the invention will be apparent from and elucidated further with reference to the embodiments described by way of example in the following description and with reference to the accompanying drawings, in which:

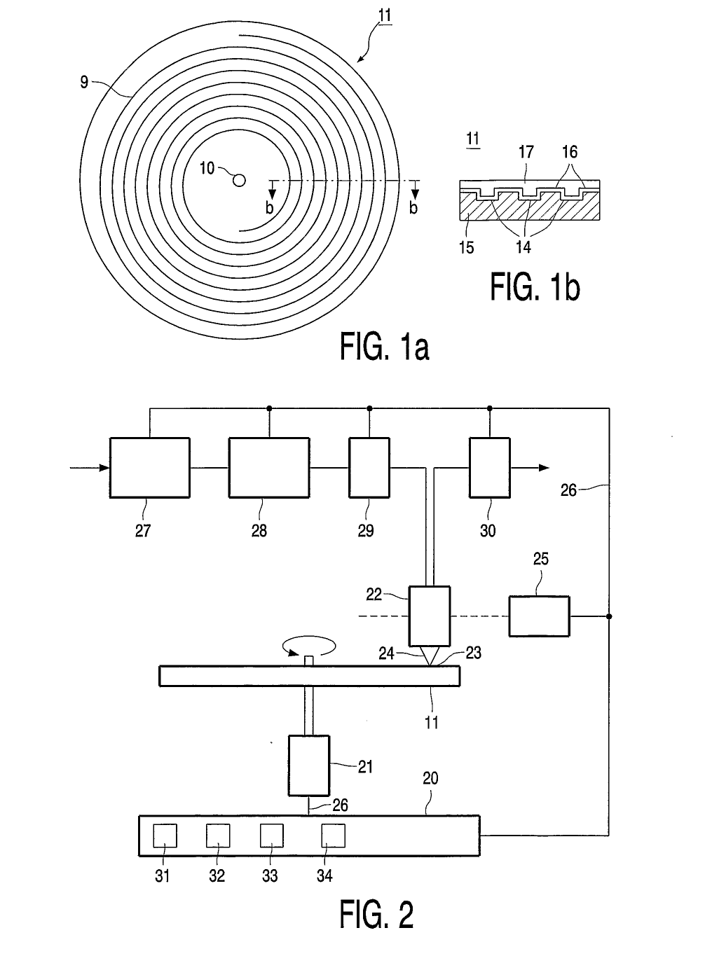

FIG. 1a shows a recording medium (top view),

FIG. 1b shows a recording medium (cross section),

FIG. 2 shows a recording device, in accordance with the invention,

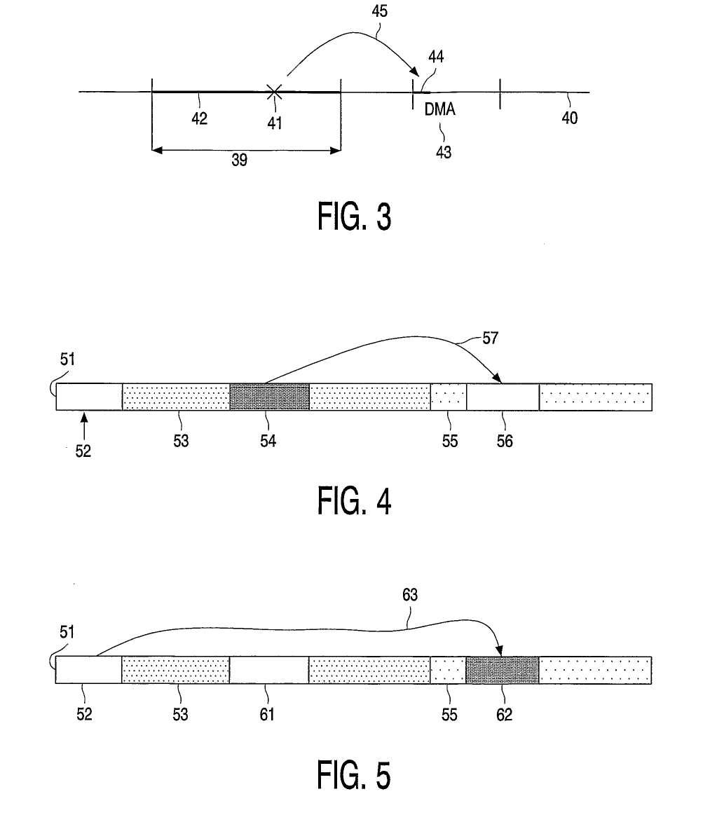

FIG. 3 shows remapping of defective locations,

FIG. 4 shows storing of additional data via remapping of user data, in accordance with the invention,

FIG. 5 shows storing of additional data in a remapping area, in accordance with the invention,

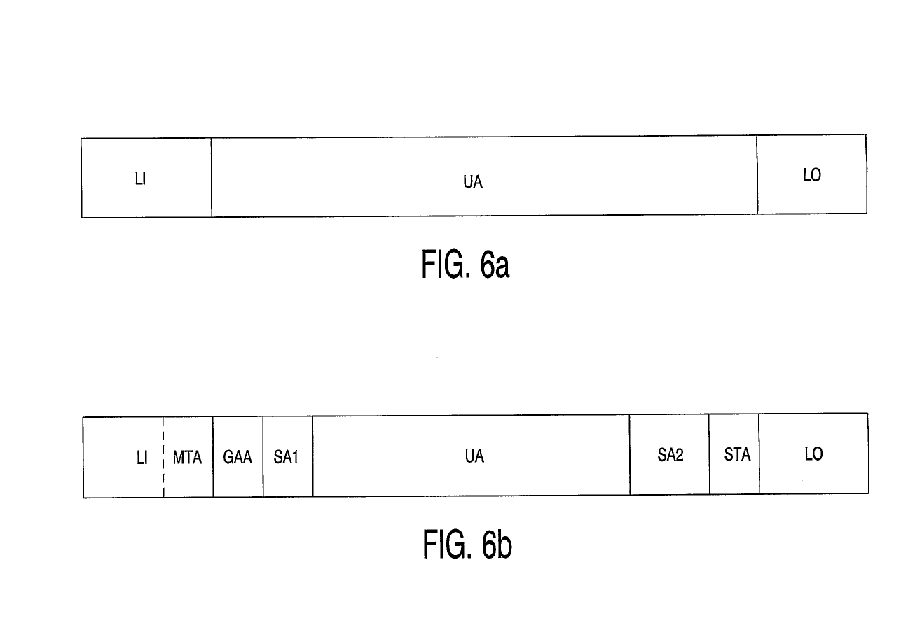

FIG. 6a shows a simplified layout of a non-MRW type of medium,

FIG. 6b shows a simplified layout of a MRW type of medium.

Corresponding elements in different Figures have identical reference numerals.

FIG. 1a shows an example of a recording medium 11 having a form of disc with a track 9 and a central hole 10. The track 9, being the position of the series of (to be) recorded marks representing information (data), is arranged in accordance with a spiral pattern of turns constituting substantially parallel tracks on an information layer. The recording medium may be optically readable, called an optical disc, and has an information layer of a recordable type. Examples of a recordable disc are the CD-RW, and writable versions of DVD, such as DVD+RW, and the high density writable optical disc using blue lasers, called Blu-ray Disc (BD). The information is represented on the information layer by recording optically detectable marks along the track, e.g. crystalline or amorphous marks in phase change material. The track 9 on the recordable type of recording medium is indicated by a pre-embossed track structure provided during manufacture of the blank recording medium. The track structure is constituted, for example, by a pregroove 14, which enables a read/write head to follow the track during scanning. The track structure comprises position information, e.g. addresses, for indication the location of units of information, usually called information blocks or packets.

FIG. 1b is a cross-section taken along the line b-b of the recording medium 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

FIG. 2 shows a recording device for recording information on a recording medium 11 such as CD-RW, DVD+RW or BD, in accordance with the invention. The apparatus is provided with writing means for scanning the track on the recording medium, which means include a drive unit 21 for rotating the recording medium 11, a head 22, and a positioning unit 25 for coarsely positioning the head 22 in the radial direction on the track. The head 22 comprises an optical system of a known type for generating a radiation beam 24 guided through optical elements focused to a radiation spot 23 on a track of the information layer of the recording medium. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading, the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve information (data). Hence retrieving means for reading information include the drive unit 21, the head 22, the positioning unit 25 and the read processing unit 30. The device comprises write processing means for processing the input information to generate a write signal to drive the head 22, which means comprise an (optional) input unit 27, and modulator means comprising a formatter 28 and a modulator 29. During the writing operation, marks representing the information are formed on the record carrier. The marks are formed by means of the spot 23 generated on the recording layer via the beam 24 of electromagnetic radiation, usually from a laser diode. Digital data is stored on the record carrier according to a predefined data format. Writing and reading of information on/from optical disks and formatting, error correcting and channel coding rules are well-known in the art, e.g. from the CD and DVD system. The input unit 27 processes input data to units of information, which are passed to the formatter 28 for adding control data and formatting the data, e.g. by adding error correction codes (ECC) and/or interleaving. For computer applications units of information may be interfaced to the formatter 28 directly—in such case, as an option, the input unit 27 does not have to be present in the apparatus. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted units presented to the input of the modulation unit 29 comprise address information and are written to corresponding addressable locations on the recording medium under the control of a control unit 20. The control unit 20, which controls the recording and retrieving of information, may be arranged for receiving commands from a user or from a host computer. The control unit 20 is connected via control lines 26, e.g. a system bus, to said input unit 27, formatter 28 and modulator 29, to the read processing unit 30, to the drive unit 21, and to the positioning unit 25. The control unit 20 comprises control circuitry, for example a microprocessor, a program memory and control gates, for performing the procedures and functions according to the invention as described below. The control unit 20 may also be implemented as a state machine in logic circuits.

In an embodiment the device is a storage system only, e.g. an optical disc drive for use in a computer. The control unit 20 is arranged to communicate with a processing unit in the host computer via a standardized interface (not shown). Digital data is interfaced to the formatter 28 and from the read processing unit 30 directly. In this case, the interface acts as an input unit and an output unit; as an option, the input unit 27 does not have to be present in the device.

In an embodiment the device is arranged as a stand alone unit, for example a video recording apparatus for consumer use. The control unit 20, or an additional host control unit included in the device, is arranged to be controlled directly by the user, and to perform the functions of the file system(s). The device includes application data processing, e.g. audio and/or video processing circuits. User information is presented on the input unit 27, which may comprise compression means for input signals such as analog audio and/or video, or digital uncompressed audio/video. The read processing unit 30 may comprise suitable audio and/or video decoding units.

A read device has the same elements as the recording device, except the specific recording elements, e.g. the read device does not have the input unit 27, the formatter 28, the modulator 29, the remapping unit 32 and the storage unit 33.

The control unit 20 is arranged for controlling the recording by locating each block at a physical address in the track, and for remapping as described below. The control unit 20 includes the following cooperating units: an addressing unit 31, a remapping unit 32, and a storage unit 33, which units are for example implemented in firmware.

The addressing unit 31 is for translating physical addresses into logical addresses and vice versa in dependence of remapping information. The logical addresses constitute a contiguous storage space to be used for storing sequences of information blocks, such as files under control of a file management system, for example UDF.

The remapping unit 32 is for managing the remapping information relating to at least one remapping area, e.g. for creating, updating and storing suitable tables of remapping information. The remapping information is indicative for translating a logical address initially mapped to a physical address in the user data area to an alternate physical address, which alternate physical address may be located in a dedicated and separate spare area, or may be provided locally by adapting the mapping of higher logical addresses (usually called slipping).

The control unit 20 can operate in two addressing modes: either a user area addressing mode or an alternative addressing mode. In the user area addressing mode, reading/writing of data used for real use and data related to content stored on a recording medium, such as user data and first file system data comprising directory and file entries pointing to the user data according to rules of a first file system, is performed. In this mode, remapping can be used. In the alternative addressing mode, reading/writing of additional data outside the user area is performed without remapping. Examples of additional data are file system data of other file system(s).

The storage unit 33 is for storing additional data, such as second file system data related to the user data. When additional data needs to be stored, the storage unit assigns a physical address to the additional data and writes the additional data at that physical address directly without any translation by the addressing unit 31. Further, the storage unit 33 adapts the remapping information to indicate that the physical addressed assigned to the additional data, an additional data physical address, is not available for storing user data. This allows for storing the additional data also in the user area addressing mode, i.e. the user data and the additional data can be stored without changing the addressing mode.

In particular, in the read device (and usually also in the recording device) the control unit includes a retrieval unit 34 for retrieving the additional data from the additional data physical address. The retrieval unit is arranged for detecting the additional data physical addresses, e.g. from a special remapping table or a special status code assigned to remapping entries. The additional data storage location may be known from other control data, or may be preset to predefined physical address locations for specific applications. Note that the retrieval unit may detect that the remapping information indicates that the some physical addresses are not available for storing user data, whereas such addresses are not defect, e.g. are not listed in defect lists.

In an embodiment, the storage unit 33 is arranged for assigning the additional data physical address at a free logical address in the user area and for adapting the remapping information to indicate that the physical address corresponding to the free logical address needs remapping. An example of this functionality is explained below with reference to FIG. 4.

In an embodiment, the storage unit 33 is arranged for assigning the additional data physical address at a free physical address in the spare area used for remapping and for adapting the remapping information to indicate that the free physical address is unusable for remapping. An example of this functionality is explained below with reference to FIG. 5.

In an embodiment, the remapping unit 32 is a defect management unit, which detects defects, for example by monitoring the signal quality of a read-out signal from the head 22 during recording and/or reading. The defects may also be detected by determining an error rate in retrieved information blocks. The defect management unit maintains the defect management information in defect management areas on the record carrier, for example in defect lists as defined for the DVD recordable systems like DVD+RW. The defect management information at least includes remapping information.

FIG. 3 shows remapping of defective locations. A physical address space 40 is schematically represented by a horizontal line. A series of blocks 42 is to be recorded in an allocated physical address range 39. However a defect 41 interrupts the allocated physical address range. Remapping 45 is the process that a block 44 having a logical address corresponding to the physical address 41 that is defective is stored in an alternative physical address in a defect management area (DMA) 43. The remapping information provides data for translating the logical address initially mapped to a physical address exhibiting a defect to an alternate physical address in a defect management area, for example an entry in a defect list including the logical address of the remapped block and its corresponding physical address. Alternatively remapping information may include data for translation of a physical address of a defect to a different physical address in a defect management area.

The defect management areas are located on the record carrier according to a recording area layout. In the layout physical address is assigned to a specific logical address of a user data area, or to a defect management area or system area, etc. The layout may be predefined, or may be defined according to parameters included in the system area. The defect management information may include assignment information indicative of assignment of physical addresses in first parts of the track to at least one user data area, assignment of physical addresses in second parts of the track to defect management areas, and assignment of the defect management information to the defect management areas. The assignment of the defect management information to the defect management areas indicates the use of the defect management area, for example a primary defect list and a secondary defect list, or replacement area for a specific type of defects.

FIG. 4 shows storing additional data via remapping of user data. A recordable area 51 of a record carrier is schematically shown, and is accessible via physical addresses. The recording area is logically subdivided and starts with a lead-in 52, followed by a user area 53 and a spare area 55. The recording area may be terminated by a lead-out (not shown). Note that in practice the location of the spare area 55 may be different, or several spare areas may be included. For example an inner spare area (ISA) may be located at an inner radial position immediately after the lead-in area, whereas an outer spare area (OSA) may be located at an outer radial position just before the lead-out area. In addition, on multilayer discs, each layer may have one or more spare areas. Note that the total amount of spare area may be a substantial part of the total data storage area of the record carrier, e.g. 50%, allowing managing a large amount of defects or overwrites, and via the current invention, additional data or additional data updates.

Additional data 54 has been recorded in the user area at the additional data physical address directly without translation of a logical address to this physical address. For this purpose a special write command can be used, which directly writes to the physical address (sometimes called a streaming write because it is intended for writing real-time data). Remapping information 57 indicates that the logical address initially corresponding to the additional data physical address has been remapped to a new location 56 for containing any user data recorded at that logical address. Note that the lead-in 52 may contain an updated defect list, which contains a replacement entry for this logical address or physical address.

In a practical embodiment the second file system data or other specific additional data is written to a location in the user area, which location is declared defect in the defect tables. Any normal write to this location leads to a replacement and the user data is physically written at the replacement address. The original location contains the additional data and the replacement locations contain the normal user data of the application, a shown in FIG. 4. The next time that an application is requesting the written user data the data from the replacement location is returned. Note that an application, which is aware of the additional data, can retrieve these data with a special read command that directly reads the physical address (sometimes called a streaming read because it is intended for reading real-time data).

FIG. 5 shows storing additional data in a remapping area. Like in FIG. 4 a recordable area 51 of a record carrier is schematically shown, and starts with a lead-in 52, followed by a user area 53 and a spare area 55. Additional data 62 has been recorded in the remapping or spare area 55 at an additional data physical address. Remapping information 63 indicates that the additional data physical address is unusable, i.e. cannot be used for remapping. Ordinary user data 61 may be stored on its original location in the user area. Note that, in a defect list in the lead-in, a replacement entry originally assigned to the logical address of user data 61 may now be changed to indicate that the replacement physical address is defect.

In a practical embodiment the second file system data or other specific additional data is directly written in the spare area via a special command directly to a free replacement address. This replacement address is declared unusable in the defect table to prevent overwrite or reuse of the physical address.

In a practical embodiment, the control unit 20 is capable of performing initialization, formatting and defect management of a rewritable medium such as a DVD+RW disc. An example of simplified layout of such disc is shown in FIG. 6b. It comprises lead-in area LI, lead-out area LO, a general application area GAA, a spare area SA (in this example comprising two sub-areas SA1 and SA2), a user area UA, and table areas MTA and STA. LI and LO contain mainly media read/write definition and administration data. The user area UA is used mainly for recording of data used for real use and data related to content stored on a recording medium, such as user data and first file system data comprising directory and file entries pointing to the user data according to rules of a first file system. The general application area GAA can be used for storage of data that does not allow replacements by the defect management, such as application programs or device drivers that can handle defects, or file system data of additional file systems. The defect management is based on a main defect table MDT stored in a main table area MTA, a secondary defect table SDT stored in a secondary table area STA and replacement areas (packets) comprised in the spare area SA1, SA2. The secondary defect table is a copy of the main defect table; SDT contains the same information as MDT. STA is used as redundancy in case of issues with MTA, and for assuring that non-MRW PC-systems can use these tables for address remapper in order to logically construct the address space, compensating for the defect management reallocation (not interpretable by non-MRW drives). The main table area MTA is located within the lead-in area LI. Recording media with a layout of the type shown in FIG. 6b are commonly referred to as Mount Rainier ReWritable (MRW) media, e.g. CD-MRW or DVD+MRW, in contrast to “non-MRW” media with a layout as in example shown in FIG. 6a. In case of DVD+MRW recording media, GAA, SA1 and SA2 have a size of 2, 8 and 120 MBytes, respectively.

Based on the MRW definitions, it is possible to ensure that MRW media can be read by non-MRW capable drives, by installing a remapping driver on the PC. This remapping driver can be obtained easily, amongst other, by using GAA, such that the file system in GAA launches an application, which installs this driver or downloads it from the Internet. For convergence with non-MRW aware CE devices, the same or a different file system, (typically ISO9960 or UDF) can be used for allowing addressing of the content typically recognized by CE devices. This is done by pointing to the multimedia content stored in UA of the MRW medium, using file system data stored in GAA, also referred to as second file system data, known by CE devices. There can be an extra file system in GAA, dedicated to performing tasks related to the remapping driver.

A defect table contains information, which can be used to perform the defect management. In particular, the defect table contains a list of defective areas (packets), which have been determined to be defective during verification or during use of the medium, according to rules of the defect management. Further, it contains a list of replacement areas (packets), reserved to be used as replacements of defective areas. Defective and replacement areas are referred to by their addresses on the medium. Different flags or status bits within the defect table indicate characteristics of those areas, e.g. usability for data recording. The defect table may also contain information related to areas on the medium, where the defect management shall not be active, such as a size and position of GAA.

In an embodiment, the storage unit 33 is adapted to mark a part of the medium as unusable in the defect table, in order to reserve it for other use than data recording under the defect management. In particular, the storage unit 33 is adapted to record second file system data in this part of the medium; those data can be employed by “non-MRW” devices or systems (generally, without or different built-in defect management functionality) to access the user data. At least the base structures of the second file system (like anchor volume descriptor pointer AVDP) always need to be in the standard GAA in order to allow the second file system to be mounted in CE-devices or any device without MRW knowledge. This can be done during formatting phase while the device is in the GAA mode.

In an embodiment, the part of the medium marked as unusable in the defect table is allocated for so-called virtual general application area VGAA and information related to this allocation is recorded on the medium, e.g. in the defect table. This effectively increases the size of GAA. The storage unit 33 writes additional data to VGAA using a special write command which directly writes to the physical address, as explained above with reference to FIGS. 4 and 5.

On the MRW medium with the CE-bridge usage capabilities, user files are recorded in UA together with the file system information (data) about these files. This is exactly the same as happens on the normal MRW medium.

The enlarged GAA can be used to present a “CE adapted” view of the user files present in UA. This means that a file system structure (a second file system data) with links to data files in UA is created in the enlarged GAA, according to CE requirements. For example, if there is DVD structured data present in UA, a file system structure according to the DVD(+VR) standard is created. Based on this file structure, this “MRW for CE enabled medium” will play in all (CE) DVD players. Other data that is of interest for CE devices (such as multi-media files or meta-data files) can be in the file system structure in GAA, as well. A predetermined directory layout for various multi-media files can be defined in this file system structure. For example, all MP3 files in UA can appear in a single directory called MP3 from a CE device point of view, independently of the directory they are put in inside UA. In a similar way, all JPEG files can be put in a directory called JPEG or PHOTOS. Of course, it is still possible to a have a further directory structure inside those directories, based on e.g. the original location or the creation date of these files. The advantage of this approach is that CE devices do not have to search through a large amount of directory trees to find all files that are of interest for them. All interesting files from a CE point of view can appear in one directory (e.g. MULTIMEDIA) or just in a limited number of directories based on the file types present on the medium.

The number of files in UA may be very high and related file systems relatively complex. In this case a special playlist and meta-data based solutions, like MPV, may be used for easy access, playback and storage of the content in UA. Such solutions may allow “write” functionality for non-MRW aware CE devices that can handle MPV information, as the MPV information stored on the medium can be used to restore integrity of the data in the PC environment by using autolaunch applications as described above, but now for a MPV application on the medium, stored in UA and/or GAA.

In an embodiment, the storage unit 33 is adapted to indicate at least a part of the spare area SA, as unusable in the defect table and to record second file system data in it.

First, space in SA1 (SA2) is freed-up by moving content in SA1 (SA2) to free areas, based on information from MDT. This can be done by e.g. background action of the apparatus, or can be the result of a special format command, which transforms “normal” MRW layout to a special one as hereunder. The freed-up SA locations are marked as unusable in the defect table. As a result, these locations will not be overwritten in MRW systems. These locations are added to the GAA space as VGAA. This change in size and layout of the GAA can be stored on the medium for future use in systems knowing this convergence solution. If the convergence file system (second file system) needs special files after the content in UA, then these can be recorded in the SA2 portion added to the GAA space.

Allocating the whole SA1 space for VGAA gives extra 8 MBytes for storing the second file system data; this means about 4000 additional file/directory entries in case of UDF as the second file system. If necessary, a part of or even all 120 MBytes of SA2 space can be used for this purpose.

Alternatively, or in addition to the space from SA, a part of UA can also be allocated for VGAA and used for recording the second file system data.

This can be achieved by changing the user area available to the file system in UA—making parts of the file system space unusable or getting parts out of the file system allocation space. Next, the freed space can be added to the GAA space, e.g. by means of a special table of freed up addresses. This special table can be included in the defect table.

In another embodiment, the storage unit 33 is adapted to indicate a part of the user area UA, as unusable in the defect table and to record second file system data in it. Extending GAA into UA is done almost the same way as extending GAA into SA, as described above, but now by copying content of the beginning (or other part) of UA to free location(s) in SA (e.g. in SA2, if SA1 is already allocated for VGAA), creating related defect tables entries in MDT (and SDT) and marking the original UA location(s) as unusable in the defect tables. Of course, said copying of the content is not necessary if no data is present in that part of UA. This allows to enlarge GAA into these freed-up location(s); in this way e.g. 100 MBytes of space can be easily added to GAA as VGAA, thus breaking almost all use limits for the size of the (second) file system data used for the CE convergence.

In a practical embodiment the write commands are as follows. For the Mount Rainier standard for rewritable optical discs there are two read and two write commands of interest. These are the so-called Read10 and Read12 commands and the Write10 and Write12 commands. The Read10 and Write10 can be seen as the normal read and write commands for accessing data in UA. The Mount Rainier drive analyses the addresses given in these commands and applies the replacement defect management if applicable. The Read12 and Write 12 (with the streaming flag set) are referred to as the Streaming-read and Streaming-write commands for accessing data in UA. These can be seen as ‘physical read’ and ‘physical write’. The Mount Rainier drive doesn't apply any defect management and just returns all data it reads from the address range given in the command, without returning any defect flag when a defect is encountered on the disc. The same applies for writing data.

The Read12 and Write12 are examples of special commands for directly accessing data as mentioned above with reference to FIG. 4.

Alternatively, direct access to data is performed by special read/write commands using negative numbers to represent physical addresses, contrary to normal commands using positive numbers to represent logical addresses.

Alternatively, an extra bit can be added to the existing Read10/Write10 commands to indicate physical addressing.

In a practical embodiment, the part of UA allocated as VGAA has the same size as SA1. Any normal reading/writing to this part is remapped to SA1, whereas special, direct reading/writing is used to access data in VGAA.

VGAA can be located in any part of UA; it can also be split into sections. In an embodiment, the storage unit 33 is adapted to select a part of UA out of the first file system allocation space and add it to the GAA space. This means that no user data can be stored in this part of UA under control of the first file system. This part can be added to GAA by means of a special list of freed up addresses comprised in the defect table.

In an embodiment, the storage unit 33 is adapted to allocate several parts of UA as VGAA.

In an embodiment, the storage unit 33 is adapted to dynamically allocate more space for VGAA at the cost of UA, when the amount of the VGAA space needed for storing additional data is bigger than anticipated originally, e.g. during formatting of the disc.

It is noted that the function of the storage unit 33 and the retrieval unit 34 can be performed as a process of storing additional data in a separate device, for example as a computer program in a host computer controlling a disc drive. The drive accommodates physically recording and retrieving of information in blocks having logical addresses on the record carrier by locating each block at a physical address in the track, translating the logical addresses into the physical addresses and vice versa in dependence of remapping information.

An embodiment of a computer program product according to the invention is operative to cause the control unit 20 or a processor in a computer to perform methods and functions as described in reference to embodiments of the recording device presented above.

Whilst the invention has been described with reference to preferred embodiments thereof, it is to be understood that these are not limitative examples. Thus, various modifications may become apparent to those skilled in the art, without departing from the scope of the invention, as defined by the claims and the embodiments. Further, the invention lies in each and every novel feature or combination of features described above. Also, for the storage medium an optical disc has been described, but other media, such as a magneto-optical disc or magnetic tape, can be used. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. Device for recording information in blocks having logical addresses in a user area on a removable rewritable record carrier, which device comprises
recording means (22) for recording marks in a track on the record carrier representing the information, and
control means (20) for controlling the recording by locating each block at a physical address in the track, the control means comprising
addressing means (31) for translating the logical addresses into the physical addresses and vice versa in dependence on remapping information,
remapping means (32) for managing the remapping information relating to at least one remapping area, the remapping information being indicative for translating a logical address initially mapped to a physical address in the user area to an alternate physical address in the at least one remapping area, and
storage means (33) for storing additional data, the storage means being arranged for—assigning an additional data physical address to the additional data and adapting the remapping information to indicate that the additional data physical address is not available for storing user data, and for
writing the additional data at the additional data physical address directly without said translating.

2. Device as claimed in claim 1, wherein the storage means are for storing file system data.

3. Device as claimed in claim 1, wherein the storage means (33) are arranged for assigning the additional data physical address at a free physical address in the at least one remapping area and for adapting the remapping information to indicate that the free physical address is unusable for remapping.

4. Device as claimed in claim 1, wherein the storage means (33) are arranged for assigning the additional data physical address at a free logical address in the user area and for adapting the remapping information to indicate that the physical address corresponding to the free logical address needs remapping.

5. Device as claimed in claim 4, wherein said adapted remapping information indicates a defect at the additional data physical address corresponding to the free logical address.

6. Device as claimed in claim 1, wherein the storage means (33) are arranged for writing the additional data at the additional data physical address in response to a write command with a parameter representing the additional data physical address by a negative number.

7. Device as claimed in claim 1, wherein the storage means (33) are arranged for writing the additional data at the additional data physical address in response to a streaming write command.

8. Device as claimed in claim 1, wherein the remapping means (32) are arranged for performing defect management in the user area by remapping a physical address that has a defect to an alternate physical address for containing the content of a block at the defect physical address.

9. Method of storing additional information for use in recording information in blocks having logical addresses in a user area on a removable rewritable record carrier, which recording comprises
locating each block at a physical address in a track on the record carrier,
translating the logical addresses into the physical addresses and vice versa in dependence on remapping information, and
managing the remapping information relating to at least one remapping area, the remapping information being indicative for translating a logical address initially mapped to a physical address in the user area to an alternate physical address, the method comprising
assigning an additional information physical address to the additional information and adapting the remapping information to indicate that the additional information physical address is not available for storing user data;
writing the additional information at the additional information physical address directly without said translating.

10. Method as claimed in claim 9, wherein the additional information is file system data.

11. Method as claimed in claim 9, wherein the additional information physical address is assigned at a free physical address in the at least one remapping area and the remapping information is adapted to indicate that the free physical address is unusable for remapping.

12. Method as claimed in claim 9, wherein the additional information physical address is assigned at a free logical address in the user area and the remapping information is adapted to indicate that the physical address corresponding to the free logical address needs remapping.

13. Method as claimed in claim 12, wherein said adapted remapping information indicates a defect at the additional information physical address corresponding to the free logical address.

14. Method as claimed in claim 9, wherein the additional information is written at the additional information physical address in response to a write command with a parameter representing the additional data physical address by a negative number.

15. Method as claimed in claim 9, wherein the additional information is written at the additional information physical address in response to a streaming write command.

16. Method as claimed in claim 9, comprising performing defect management in the user area by remapping a physical address that has a defect to an alternate physical address for containing the content of a block at the defect physical address.

17. Computer program product for storing additional information for use in recording information, which program is operative to cause a processor to perform the method as claimed in claim 9.
